(19) United States
(12) Patent Application Publication
(10) Pub. No.: US 2018/0276161 A1
(43) Pub. Date: Sep. 27, 2018

(54) PCIe VIRTUAL SWITCHES AND AN OPERATING METHOD THEREOF

(71) Applicant: SK Hynix Memory Solutions Inc., San Jose, CA (US)

(72) Inventor: Sungjoon AHN, Cupertino, CA (US)

(21) Appl. No.: 15/909,702

(22) Filed: Mar. 1, 2018

Related U.S. Application Data
(60) Provisional application No. 62/477,351, filed on Mar. 27, 2017.

(51) Int. Cl. G06F 13/40; G06F 11/22; G06F 9/4401

(52) U.S. Cl. CPC G06F 13/4009; G06F 13/404; G06F 13/4221; G06F 9/4411; G06F 11/2221

(57) ABSTRACT

A memory system and an operating method thereof include: at least a host; and at least PCIe coupled with the host, wherein the at least PCIe link includes at least a PCIe switch and a plurality of PCIe endpoints, wherein the plurality of PCIe endpoints includes used PCIe endpoints and unused PCIe endpoints, the used PCIe endpoints are mapped into a PCIe enumeration tree, and the unused PCIe endpoints are removed from the PCIe enumeration tree, at virtual switch mode.

### CROSS REFERENCE TO OTHER APPLICATIONS

This application claims priority to U.S. Provisional Patent Application No. 62/477,351 entitled PCIe VIRTUAL SWITCH filed Mar. 27, 2017, which is incorporated herein by reference for all purposes.

### BACKGROUND

### Field of Invention

Exemplary embodiments of the present invention relate to an apparatus of semiconductor memory storage system, and more particularly to diagnose SSD and an operation method thereof.

### Description of Related Arts

The computer environment paradigm has shifted to ubiquitous computing systems that can be used anytime and anywhere. Due to this fact, the use of portable electronic devices such as mobile phones, digital cameras, and notebook computers has rapidly increased. These portable electronic devices generally use a memory system having memory devices, that is, a data storage device. The data storage device is used as a main memory device or an auxiliary memory device of the portable electronic devices. Thus, the reliability and security of digital data storage, such as a memory system is critical.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

The SSD can include various flash memory components. The two main types of flash memory components are named after the NAND and NOR logic gates. The individual flash memory cells exhibit internal characteristics similar to those of the corresponding gates. The NAND-type flash memory may be written and read in blocks (or pages) which are generally much smaller than the entire device. The NAND-type operates primarily in memory cards, USB flash drives, solid-state drives, and similar products, for general storage and transfer of data.

Reliability of the memory system is a very important component of the all flash array. Virtual switch mode utilized in the memory system is particularly crucial and needs to be accomplished for prevent the server in the memory system from hanging or crashing for certain implementations.

Thus, there remains a need for a semiconductor memory system and operating method thereof having virtual switch mode. In view of the ever-increasing need to improve performance and reliability, it is more and more critical that answers can be found to these problems. Solutions to these problems have been long sought but prior developments have not taught or suggested any solutions and, thus, solutions to these problems have long eluded those skilled in the art.

### SUMMARY

Embodiments of the present disclosure are directed to a semiconductor memory system and an operating method thereof capable of improving the performance and reliability of a memory system.

In accordance with an embodiment of the present disclosure, there is provided with an apparatus of a memory system which includes: A memory system and an operating method thereof include: at least a host; and at least a PCIe link coupled with the host, wherein the at least PCIe link includes at least a PCIe switch and a plurality of PCIe endpoints, wherein the plurality of PCIe endpoints includes used PCIe endpoints and unused PCIe endpoints, the used PCIe endpoints are mapped into a PCIe enumeration tree, and the unused PCIe endpoints are removed from the PCIe enumeration tree, at virtual switch mode.

In accordance with an embodiment of the present disclosure, there is provided with a method of operating a semiconductor memory system which includes: providing at least a host; coupling at least a PCIe link with the host, wherein the at least PCIe link includes at least a PCIe switch and a plurality of PCIe endpoints, wherein the plurality of PCIe endpoints includes used PCIe endpoints and unused PCIe endpoints; at virtual switch mode, mapping the used PCIe endpoints into a PCIe enumeration tree; and removing the unused PCIe endpoints from the PCIe enumeration tree.

### BRIEF DESCRIPTION OF THE DRAWINGS

FIG. 1 is a top level block diagram schematically illustrating a prototype of flash array system in accordance with an embodiment of the present invention.

FIG. 2 is a diagram schematically illustrating a PCIe system of a flash array system in accordance with an embodiment of the present invention.

FIG. 3 is a diagram schematically illustrating virtual switch mode of PCIe switches in accordance with an embodiment of the present invention.

FIG. 4(A) is a diagram schematically illustrating virtual switch mode of PCIe switches in accordance with an embodiment of the present invention.

FIG. 4(B) is a diagram schematically illustrating virtual switch mode of PCIe switches in accordance with an embodiment of the present invention.

FIG. 5 is a diagram illustrating virtual switch mode steps of a memory system in accordance with an embodiment of the present invention.

FIG. 6 is a flowchart illustrating an operating method of a memory system in accordance with an embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The invention can be implemented in numerous ways, including as a process; an apparatus; a system; a composition of matter; a computer program product embodied on a computer readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily suitable for performing the task at a given time or a specific component that is manufactured to perform the task. As used herein, the term ‘processor’ refers to one or more devices, circuits, and/or processing cores suitable for processing data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A memory system of embodiments of present invention, such as an all flash array system, may comprise a server or servers coupled with multiple SSDs of tens to hundreds through a PCIe system. Problems in the currently technology, the server or servers of the memory system may encounter problem of hanging or crashing due to limited PCIe enumeration capability of the PCIe system. The PCIe system may comprise PCIe links having a plurality of PCIe endpoints.

Number of PCIe endpoints of the PCIe system may be limited by the PCIe enumeration capability of the server or servers, such as host Basic Input/Output System (BIOS). Frequently, the servers/hosts cannot enumerate a maximum number of the PCIe endpoints, such as 255. When the number of the PCIe endpoints of the PCIe system exceeds what the server/host BIOS can enumerate, usually the server/host may hangs/crashes. Conventional methods of disabling downstream ports on a PCIe enumeration tree may not eliminate all floating PCIe nodes and still leave some intermediate PCIe nodes, which still can be counted towards the PCIe endpoints and limit the PCIe enumeration capability.

The embodiments of the present invention propose a scheme to use virtual switch mode of PCIe switches to streamline the PCIe enumeration tree. The embodiments of the present invention can save server resources by removing a few unconnected PCIe endpoints in the PCIe enumeration tree with virtual switch configuration at the virtual switch mode. The scheme proposed in the embodiments of the present invention can prevent server BIOS from hanging or crashing for certain implementations by maximizing the PCIe enumeration capability, wherein the certain implementations may not archive a predetermined maximum number of PCIe devices.

In order to solve the problem addressed above, the embodiments of the present invention provide the scheme of maximizing the PCIe enumeration capability by eliminating unconnected PCIe endpoints with the virtual switch mode of PCIe switches. The memory system and the operating method thereof can include following steps.

1. A target PCIe system can be selected for streamlining the PCIe enumeration tree by utilizing the Virtual Switch mode of PCIe switches. The memory system may include multiple PCIe systems corresponding to multiple roots/hosts, respectively. Each of the multiple PCIe systems can have a corresponding server/host as the root thereof. The target PCIe system may be one of the multiple PCIe systems selected as for streamlining.

2. The Virtual Switch mode can be configured for creating the PCIe enumeration tree to support the multiple root PCIe target systems. The memory system and operating method can create a single root virtual switch mode just for creating the PCIe enumeration tree.

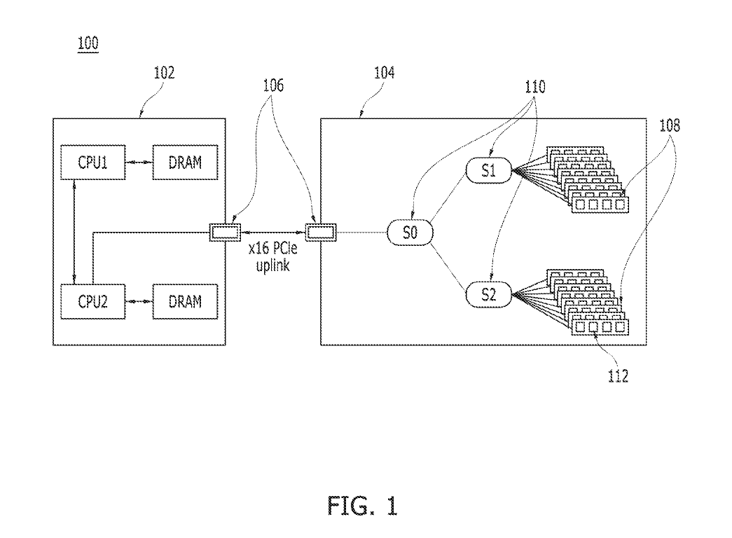

Referring now to FIG. 1, herein is shown a top level diagram schematically illustrating a prototype of flash array in accordance with an embodiment of the present invention. A memory system 100 can comprise a server 102 and a flash array 104, wherein the flash array 104 can be coupled with the server 102 through PCIe extender cards 106, such as x16 PCIe uplink. The flash array 104 can include one of the PCIe extender cards 106 coupled with SSD cards 108 through PCIe switches 110. A PCIe extender-PCIe extender can be used to connected the PCIe extender cards 106 as shown in FIG. 1.

The server 102 can include at least one CPU, wherein the at least one CPU can be coupled with the flash array 104 through the PCIe extender cards 106, and the at least one CPU can be connected with one of the PCIe extender cards 106 by a CPU-PCIe extender. The flash array 104 can include rows of the SSD cards 108, wherein each of the SSD cards 108 can carry multiple SSDs 112. The SSD cards 108 can be divided into multiple soups, and the SSD cards 108 in each group can share one of the PCIe switches 110 at a lower hierarchical level. The PCIe switches 110 at the lower hierarchical level can be connected with each other and further coupled with one of the PCIe extender cards 106, through one of the PCIe switches 110 at a higher hierarchical level.

For example, as shown in FIG. 1, the server 102 can have 2 CPUs including CPU1 and CPU2. One of the CPUs, such as CPU2, can be connected with one of the PCIe extender card 106. The flash array 104 can include the multiple SSD cards 108 divided into multiple groups, such as 16 SSD cards divided into 2 groups. Each of the SSD cards 108 can carry multiple SSDs 112, such as 4 SSD 112 carried in each of the SSD cards 108. Each group of the SSD cards 108 can be connected through one of the PCIe switches 110 of the lower hierarchical level, such as S1 and S2, and further coupled to the PCIe extender card 106 via one of the PCIe switches 110 of the higher hierarchical level, such as S0. The PCIe extender cards 106 can be connected with each other. The PCIe switches 110 can be arranged in multiple hierarchical levels, such as 2 hierarchical levels shown in FIG. 1.

The memory system 100 may comprise multiple servers or hosts, wherein each of the multiple servers or hosts may include an architecture of the server 102 and coupled flash array 104 as shown in FIG. 1.

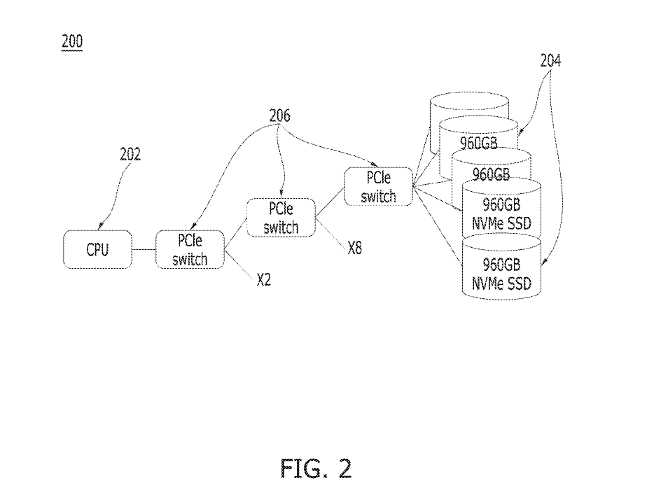

Referring now to FIG. 2, herein is shown a diagram schematically illustrating a PCIe system of a flash array system in accordance with an embodiment of the present invention. A memory system 200 can comprise at least one CPU 202 and a flash array, wherein the flash array including multiple SSDs 204 can be coupled with the CPU 202 through PCIe system including PCIe switches 206.

The PCIe switches 206 can be configured to operate at the virtual switch mode for streamlining PCIe enumeration tree. The virtual switch mode can create the PCIe enumeration tree constructed with one upstream port and multiple downstream ports mappings.

Referring now to FIG, 3, herein is shown a diagram schematically illustrating virtual switch mode of PCIe switches in accordance with an embodiment of the present invention. The virtual switch mode of the PCIe switches can be used to create a PCIe enumeration tree for a target PCIe system. Each of the PCIe switches, such as a PCIe switch 300, can create the virtual switch mapping between upstream ports and downstream ports thereof at virtual switch mode, wherein the virtual switch mapping of the PCIe switches can construct the PCIe enumeration tree. The virtual switch mapping can comprise a plurality of PCIe endpoints including used downstream PCIe ports 302, unused downstream PCIe ports 304, a used upstream PCIe port 306, and unused upstream PCIe ports 308. The upstream PCIe ports 306 can be connected to the used downstream PCIe ports 302. Although the unused downstream PCIe ports 304 and unused upstream PCIe ports 308 are floating, the PCIe enumeration tree may still include the unused PCIe endpoints.

The virtual switch mode of the PCIe switch 300 can be utilized to create virtual switch mapping for the desired PCIe enumeration tree. The scheme for creation of the virtual switch mapping of the PCIe enumeration tree may include following steps.

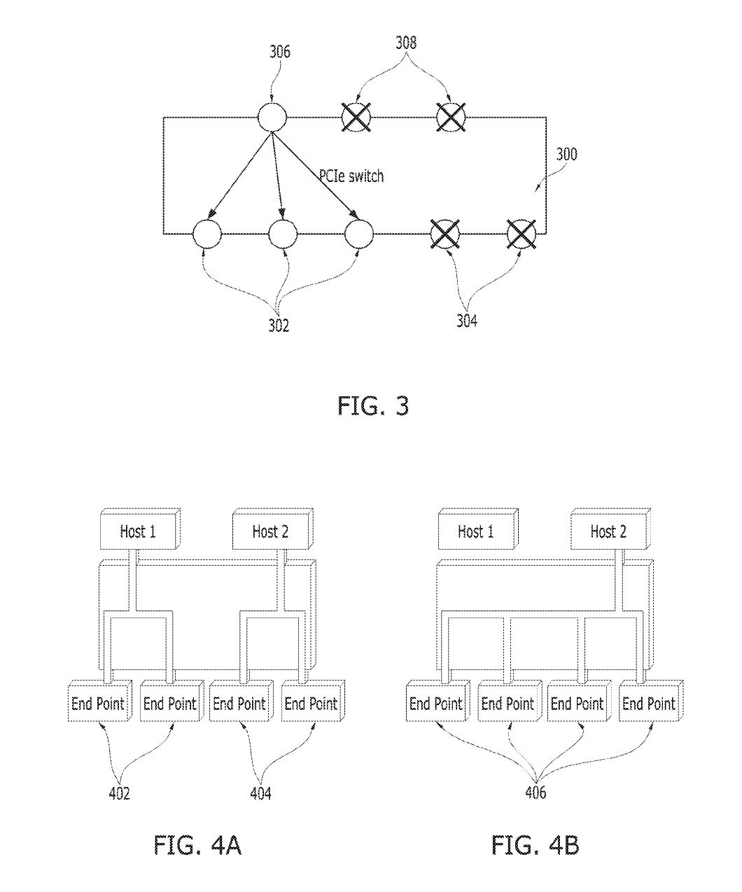

1. Identify PCIe endpoints that are needed to be included in the PCIe enumeration tree. As shown in FIG. 3, the PCIe endpoints identified to be needed and included in the PCIe enumeration tree can include the used downstream PCIe ports 302 and used upstream PCIe port 306. The unused downstream PCIe ports 304 and unused upstream PCIe ports 308 are not connected and may not be included in the virtual switch mapping.

2. Each edge of the PCIe enumeration tree can be mapped into upstream-downstream mapping configured by virtual switch configuration on the PCIe switch 300. A configuration data can be created in accordance with the upstream-downstream mapping, such as the virtual switch mapping. For example, the used upstream PCIe port 306 can be mapped with the multiple used downstream PCIe ports 302 to create the virtual switch mapping in accordance with the virtual switch configuration. The virtual switch configuration used to create corresponding virtual switch mapping including the used downstream PCIe ports 302 and used upstream PCIe port 306, can be saved for construction of the configuration data.

3. The step 2 described above can be repeated until the virtual switch configurations for all of the PCIe switches of the target PCIe system are completed, wherein at least one of the PCIe endpoints in the PCIe enumeration tree is removed. For example, originally, the unused downstream PCIe ports 304 and unused upstream PCIe ports 308 are included in the PCIe enumeration tree as well. After the virtual switch mapping are created, the unused downstream PCIe ports 304 and unused upstream PCIe ports 308 can be removed from the PCIe enumeration tree, in accordance with the virtual switch configurations.

Referring now to FIG. 4(A), herein is shown a diagram schematically illustrating virtual switch mode of PCIe switches in accordance with an embodiment of the present invention.

The virtual switch mode can provide a scheme to configure the PCIe switches, such that arbitrary numbers of upstream port—downstream ports trees can be created. For example, one upstream port—n downstream ports. In one embodiment of the present invention, the virtual switch mode can configure the PCIe switches to create a high performance PCIe enumeration tree, wherein the high performance PCIe enumeration tree can comprise multiple hosts/servers, and each of the hosts/servers can be mapped to multiple endpoints through the virtual switch mapping.

For example, as shown in FIG. 4(A), the multiple hosts/servers, such as Host1 and Host2 can be provided. The Host1 can be mapped to endpoints 402, while the Host2 can be mapped to endpoints 404. The virtual switch mapping can comprise multiple PCIe hierarchical levels, such as shown in FIG. 2. The numbers of the endpoints mapped to each of the servers/hosts can be different or equal in accordance with the virtual switch configurations. The virtual switch configurations can be configured in accordance with the corresponding host/server to maximize the performance of the memory system. Each of the hosts and the PCIe system thereof can be optimized with virtual switches following steps discussed above.

Referring now to FIG. 4(B), herein is shown a diagram schematically illustrating virtual switch mode of PCIe switches in accordance with an embodiment of the present invention.

The virtual switch mode can provide a scheme to configure the PCIe switches, such that arbitrary numbers of upstream port-downstream ports trees can be created. For example, one upstream port-n downstream ports. In one embodiment of the present invention, the virtual switch mode can configure the PCIe switches to create a high availability PCIe enumeration tree, wherein the high availability PCIe enumeration tree can comprise multiple hosts/server, each of the hosts/servers can be mapped to multiple endpoints through the virtual switch mapping. When one or more of the multiple hosts/servers is failed, such as a failover situation, the endpoints mapped to the failed hosts/servers can be remapped to other available hosts/servers. Alternatively, for a memory system having a single main host or server, when the main host or server is failed, the endpoints may be remapped to another host/server, such as a standby host/server. The High availability of the memory system can be achieved by creating multiple upstream ports and mapped to the standby host when the main host fails.

For example, as shown in FIG. 4(B), the multiple hosts/servers, such as a main host of Host1 and standby host of Host2, can be provided. The Host1 can be mapped to endpoints 406 in the virtual switch mapping in accordance with the virtual switch configurations initially. The virtual switch mapping can comprise multiple PCIe hierarchical levels, such as shown in FIG. 2. When the main host of Host1 is failed, the endpoints mapped thereto can be remapped to the standby host of Host2 according to the virtual switch configurations. The virtual switch configurations can be configured in accordance with the corresponding host/server to maximize the availably of the memory system. Each of the hosts and the PCIe system thereof can be optimized with virtual switches following steps discussed above.

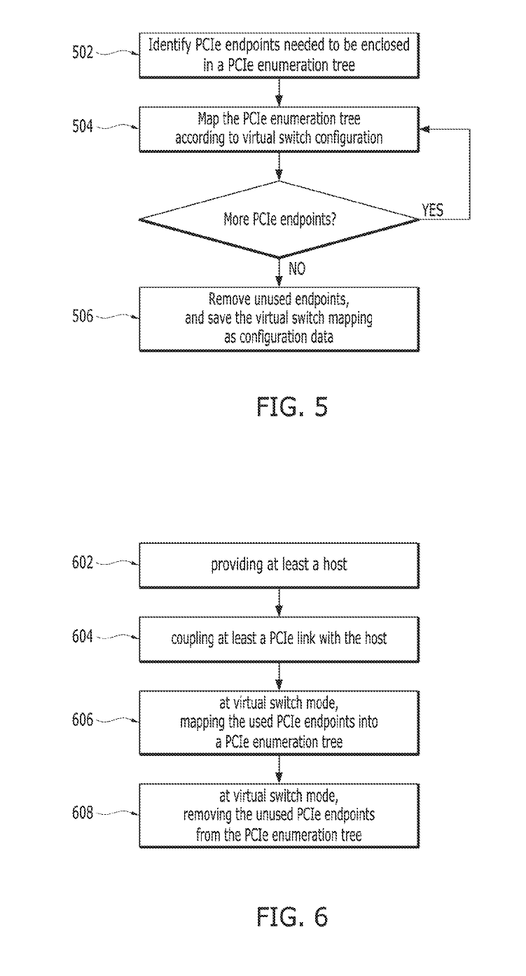

Referring now to FIG. 5, herein is shown a diagram illustrating virtual switch mode steps of a memory system in accordance with an embodiment of the present invention.

The virtual switch mode of the PCIe switches can be implemented in the following steps. Step 502, the memory system can identify the PCIe endpoints of the PCIe switches needed to be enclosed in a PCIe enumeration tree.

Step 504, one edge of the PCIe enumeration tree comprising the identified PCIe endpoints can be mapped into upstream-downstream mapping according to a virtual switch configuration on the PCIe switches.

If all of the identified PCIe endpoints in the PCIe enumeration tree are mapped into virtual switch mapping, the virtual switch mapping of all identified PCIe endpoints can be saved for constructing the configuration data in step 506. Any unused PCIe endpoints in the PCIe enumeration tree may not be mapped and may be removed from the PCIe enumeration tree.

If not all of the identified PCIe endpoints in the PCIe enumeration tree are mapped into virtual switch mapping, the step 504 can be repeated until all of the identified PCIe endpoints are mapped.

Referring now to FIG. 6, herein is shown a flowchart illustrating an operating method of a memory system in accordance with a further embodiment of the present invention. An operating method of a memory system comprising: providing at least a host in a block of 602; coupling at least a PCIe link with the host, wherein the at least PCIe link includes at least a PCIe switch and a plurality of PCIe endpoints, wherein the plurality of PCIe endpoints includes used PCIe endpoints and unused PCIe endpoints in a block of 604; at virtual switch mode, mapping the used PCIe endpoints into a PCIe enumeration tree in a block of 606; and removing the unused PCIe endpoints from the PCIe enumeration tree in a block of 608.

It has been discovered that a memory system and operating method thereof disclosed in the embodiments of the present invention can utilize the PCIe virtual switch to optimize nodes in a PCIe enumeration tree. The memory system and operating method thereof with the PCIe virtual switch can eliminate unused nodes in the PCIe enumeration tree and optimize the used nodes. Because host server's BIOS or OS may have limits on the number of nodes, optimization with the PCIe virtual switch can enumerate more nodes in the PCIe enumeration tree with more physical PCIe device, and trunk redundant connection among the nodes or upstream/downstream ports, resulting in overall improvement of the system performance.

Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters hitherto fore set forth herein or shown in the accompanying drawings are to be interpreted in an illustrative and non-limiting sense.

What is claimed is:

1. A memory system comprising:
at least a host; and
at least a PCIe link coupled with the host, wherein the at least PCIe link includes at least a PCIe switch and a plurality of PCIe endpoints, wherein
the plurality of PCIe endpoints includes used PCIe endpoints and unused PCIe endpoints, the used PCIe endpoints are mapped into a PCIe enumeration tree, and the unused PCIe endpoints are removed from the PCIe enumeration tree, at virtual switch mode.

2. The memory system recited in claim 1 wherein the PCIe enumeration tree includes virtual switch mapping between upstream PCIe ports and downstream PCIe ports of the plurality of PCIe switch.

3. The memory system recited in claim 1 wherein the used PCIe endpoints include PCIe endpoints identified in accordance with virtual switch configurations.

4. The memory system recited in claim 1 wherein the used PCIe endpoints include PCIe endpoints identified needed to be included in the PCIe enumeration tree.

5. The memory system recited in claim 2 wherein the virtual switch mapping includes virtual switch mapping conducted in accordance with virtual switch configurations.

6. The memory system recited in claim 2 wherein the virtual switch mapping includes each edge in the PCIe enumeration tree mapped into upstream-downstream mapping of virtual switch configuration on the PCIe switch.

7. The memory system recited in claim 6 wherein the virtual switch mapping is performed repeatedly for all PCIe switches.

8. The memory system recited in claim 7 further comprising configuration data in accordance with virtual switch mapping.

9. A method of operating a memory system comprising:
providing at least a host;
coupling at least a PCIe link with the host, wherein the at least PCIe link includes at least a PCIe switch and a plurality of PCIe endpoints, wherein the plurality of PCIe endpoints includes used PCIe endpoints and unused PCIe endpoints;
at virtual switch mode,
mapping the used PCIe endpoints into a PCIe enumeration tree; and
removing the unused PCIe endpoints from the PCIe enumeration tree.

10. The method recited in claim 9 wherein the mapping the used PCIe endpoints into the PCIe enumeration tree includes creating virtual switch mapping between upstream PCIe ports and downstream PCIe ports of the plurality of PCIe switch.

11. The method recited in claim 9 further comprising identifying the used PCIe endpoints in accordance with virtual switch configurations.

12. The method recited in claim 9 further comprising identifying the used PCIe endpoints needed to be included in the PCIe enumeration tree.

13. The method recited in claim 10 wherein the creating virtual switch mapping includes creating virtual switch mapping in accordance with virtual switch configurations.

14. The method recited in claim 10 wherein the creating virtual switch mapping includes mapping each edge in the PCIe enumeration tree into upstream-downstream mapping of virtual switch configuration on the PCIe switch.

15. The method recited in claim 14 wherein the creating virtual switch mapping is performed repeatedly for all PCIe switches.

16. The method recited in claim 15 further comprising creating configuration data in accordance with virtual switch mapping.
